(19) United States
(12) Patent Application Publication
(10) Pub. No.: US 2009/0120549 A1
(43) Pub. Date: May 14, 2009

(54) Tires for Two-Wheeled Vehicles

(75) Inventors: Alain Valle, Cebazat (FR); Pascal Prost, Riom (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche Et Technique S.A., Granges-Paccot (CH)

(21) Appl. No.: 11/920,760

(22) PCT Filed: May 16, 2006
(86) PCT No.: PCT/EP2006/062334

§ 371 Date: Nov. 19, 2007

(30) Foreign Application Priority Data
May 18, 2005 (FR) 0505058

(51) Int. Cl. B60C 9/18

(52) U.S. Cl. 152/527

(57) ABSTRACT

A tire for a motorized two-wheeled vehicle and more particularly a motorcycle. A tire such as this comprises at least one reinforcing structure of the carcass type, formed of reinforcing elements, anchored on each side of the tire into a bead the base of which is intended to be mounted on a rim seat, each bead extending radially outwards in the form of a sidewall, the sidewalls radially towards the outside meeting a tread, and comprising, under the tread, a crown reinforcing structure consisting of at least one layer of reinforcing elements, the said reinforcing elements making an angle of between 10 and 90° with respect to the circumferential direction. The reinforcing elements that make an angle of between 10 and 90° with respect to the circumferential direction are metal cords for which the curve of tensile stress as a function of relative elongation exhibits shallow gradients for small elongations and a substantially constant and steep gradient for greater elongations.

The present invention relates to a tire intended to be fitted to a two-wheeled vehicle such as a motorcycle.

Although not restricted to such an application, the invention will be more particularly described with reference to such a motorcycle or motorbike tire.

The body plies which reinforce tires and particularly motorcycle tires currently—and usually—consist of stacks of one or more plies conventionally termed “carcass plies”, “crown plies”, etc. This way of naming the body plies stems from the manufacturing method which consists in producing a series of semi-finished products in the form of plies, provided with thread-formed reinforcements, often longitudinal ones, which are later assembled or stacked to form a tire blank. The plies are produced in the flat state, with significant dimensions, and are then cut to suit the dimensions of a given product. The plies are also, in an initial stage, assembled in a substantially flat state. The blank thus produced is then shaped to adopt the toroidal profile typical of tires. The semi-finished so-called “finishing” products are then applied to the blank, to obtain a product ready to be cured.

A “conventional” type of method such as this involves, particularly in the phase of manufacturing the tire blank, the use of an anchoring element (generally a bead wire) used to anchor or hold the carcass in the region of the beads of the tire. Thus, in this type of method, a portion of all the plies that make up the carcass (or just some of them) is or are wrapped around a bead wire positioned in the bead of the tire. Thus the carcass is anchored into the bead.

The fact that this conventional type of method is widespread throughout the tire-manufacturing industry, in spite of there being numerous alternative ways of producing the plies and the assemblies, has led those skilled in the art to employ a vocabulary hinged on the method: hence the terminology generally accepted which in particular includes the terms “plies”, “carcass”, “bead wire”, “shaping” to denote the change from a flat profile to a toroidal profile, etc.

Nowadays there are tires which do not strictly speaking have any “plies” or “bead wires” consistent with the above definitions. For example, document EP 0 582 196 describes tires manufactured without the use of semi-finished products in the form of plies. For example, the reinforcing elements of the various reinforcing structures are applied directly to the adjacent layers of rubber compounds, all of this being applied in successive layers to a toroidal core the shape of which allows a profile similar to the final profile of the tire being manufactured to be obtained directly. Thus, in this case, there are no longer any “semi-finished” products or any “plies”, or any “bead wires”. The base products, such as the rubber compounds and the reinforcing elements in the form of threads or filaments are applied directly to the core. Since this core is of toroidal shape, there is no longer any need to shape the blank in order to change from a flat profile to a profile in the shape of a torus.

Furthermore, the tires described in that document do not have any “traditional” wrapping of the carcass ply around a bead wire. That type of anchorage is replaced by an arrangement whereby circumferential threads are positioned adjacent to the said sidewall reinforcing structure, everything being embedded in an anchoring or bonding rubber compound.

There are also methods of assembly onto a toroidal core that employ semi-finished products specially adapted for rapid, effective and simple placement on a central core. Finally, it is also possible to use a hybrid comprising both certain semi-finished products for achieving certain architectural aspects (such as plies, bead wires, etc.) while others are achieved by applying compounds and/or reinforcing elements directly.

In this document, in order to take account of recent technological evolutions both in the field of manufacture and in the design of the products, the conventional terms such as “plies”, “bead wires”, etc., are advantageously replaced with terms that are neutral or independent of the type of method used. Thus, the term “carcass-type reinforcement” or “sidewall reinforcement” can be used to denote the reinforcing elements of a carcass ply in the conventional method, and the corresponding reinforcing elements, generally applied to the sidewalls, of a tire produced using a method that does not involve semi-finished products. The term “anchoring region” for its part, can denote the “traditional” wrapping of the carcass ply around a bead wire in a conventional method just as easily as it can denote the assembly formed by the circumferential reinforcing elements, the rubber compound and the adjacent sidewall reinforcing portions of a bottom region produced using a method that involves application onto a toroidal core.

As in the case with all other tires, motorbike tires are tending towards a radial design, the architecture of such tires involving a carcass formed of one or two layers of reinforcing elements that make an angle possibly of between 65° and 90° with respect to the circumferential direction, the said carcass being radially surmounted by a crown reinforcement formed at least of reinforcing elements generally made of textiles. Nonetheless, there do remain some non-radial tires to which the invention also relates. The invention also relates to partially radial tires, that is to say tires in which the carcass reinforcing elements are radial over at least part of the said carcass, for example in the part corresponding to the crown of the tire.

Numerous crown reinforcement architectures have been proposed, depending on whether the tire is intended to be fitted to the front of the motorbike or to the rear. A first structure consists, in the case of the said crown reinforcement, in using only circumferential cords, and the said structure is more particularly used for the rear tire. A second structure, which takes its inspiration directly from the structures currently used on passenger vehicle tires, has been used to improve the resistance to wear and consists in using at least two crown layers of reinforcing elements which are mutually parallel within each layer but crossed from one layer to the next, making acute angles with respect to the circumferential direction, such tires being more particularly suited to the front wheel of motorbikes. The said two crown layers may be associated with at least one layer of circumferential elements, generally obtained by helically winding a strip of at least one rubber-coated reinforcing element.

Patent FR 2 561 588 thus describes such a crown reinforcement, with at least one ply the reinforcing elements of which make an angle that can vary between 0° and 8° with respect to the circumferential direction, the elastic modulus of such elements being as high as at least 6000 N/mm² and, positioned between the carcass and the ply made up of circumferential elements, a cushioning layer formed mainly of two plies of elements which are crossed from one ply to the next, making angles of between 60° and 90° with respect to one another, the said crossed plies being formed of textile reinforcing elements with an elastic modulus of at least 6000 N/mm².

Document EP 0 456 933, with a view to giving a motorbike tire excellent high-speed stability and excellent ground-contact properties, teaches, for example, how to build a crown reinforcement with at least two plies: a first ply, radially closest to the carcass being made up of cords orientated at an angle of between 40° and 90° with respect to the circumferential direction and the second ply, radially closest to the tread, being made up of cords helically wound in the circumferential direction.

Patent U.S. Pat. No. 5,301,730, with a view to increasing the traction of a tire for a motorbike rear wheel, proposes a crown reinforcement made up, from the radial carcass out to the tread, of at least one ply of substantially circumferential elements and two plies of elements which are crossed from one ply to the next, making an angle that may range from 35° and 55° with respect to the circumferential direction, the ply of elements parallel to the circumferential direction possibly being formed of elements made of aromatic polyamide, and the plies of crossed elements of aliphatic polyamide.

Current tires in which the reinforcing elements of the working layers make a non-zero angle, and usually an angle of between 20 and 55°, require the use of textile reinforcing elements such as aromatic polyamides or aliphatic polyamides depending on the rigidity required.

Although less attractive than metal reinforcing elements particularly in terms of manufacturing cost, textile reinforcing elements are dictated for these applications to the reinforcing element working crown layers at angles of between 20 and 55° for motorcycle tires.

There are several factors that explain this technical choice: firstly, conventional manufacturing methods which consist in using prefabricated elements such as plies are incompatible with the curvature of a motorcycle tire if the reinforcing elements in the working layers at non-zero angles are made of metal. This is because the rigidity of prefabricated elements comprising metal reinforcing elements makes it practically impossible for the said elements to be laid onto a toric profile, and at the very least, makes this impossible from an industrial viewpoint.

Second, again because of the highly pronounced curvature of motorcycle tires, the reinforcing elements at non-zero angles are subjected to compression and extension cycles at the area of contact because of the way the tire is compressed. During use of a motorcycle tire, these compression and extension cycles cause the reinforcing elements to rupture at the edge of the contact area if these elements are made of metal, the said compression and extension cycles being highly prejudicial to the durability of metal cords.

Within the meaning of the invention, the longitudinal direction of the tire, or circumferential direction, is the direction corresponding to the periphery of the tire and defined by the direction in which the tire runs.

A circumferential plane or a circumferential section plane is a plane perpendicular to the axis of rotation of the tire. The equatorial plane is the circumferential plane that passes through the centre or crown of the tread.

The transverse or axial direction of the tire is parallel to the axis of rotation of the tire.

A radial plane contains the axis of rotation of the tire.

It is an object of the invention to produce tires, particularly for motorcycles, which have properties comparable with those of present-day tires but can be produced at lower costs.

This object has been achieved according to the invention using a tire for a motorized two-wheeled vehicle such as a motorcycle, comprising at least one reinforcing structure of the carcass type, formed of reinforcing elements, anchored on each side of the tire into a bead the base of which is intended to be mounted on a rim seat, each bead extending radially outwards in the form of a sidewall, the sidewalls radially towards the outside meeting a tread, and comprising, under the tread, a crown reinforcing structure consisting of at least one layer of reinforcing elements, the said reinforcing elements making an angle of between 10 and 90° with respect to the circumferential direction and being metal cords of which the curve of tensile stress as a function of relative elongation exhibits shallow gradients for small elongations and a substantially constant and steep gradient for greater elongations.

Additional ply reinforcing cords such as this are customarily known as “bimodulus” cords.

The invention more advantageously relates to tires in which the reinforcing elements of the said layer make an angle of less than 80°, and more preferably still less than 60°, with respect to the circumferential direction.

In the course of studies, it was demonstrated that a motorcycle tire according to the invention can, by contrast with that which is known by those skilled in the art, withstand the compression and extension cycles that occur in the contact area during running.

Tests carried out on tires produced according to the invention in fact demonstrated that the tires had entirely satisfactory durability and, in particular, did not exhibit any weakness in the usual regions as a result of the compression and extension cycles that occur in the region of the contact area.

In an advantageous alternative form of the invention, particularly in order to optimize the rigidities of the reinforcing structure along the meridian of the tire, and in particular at the edges of the layers of reinforcing elements that make an angle of between 10 and 90° with respect to the circumferential direction, the angles formed by the said metal cords with respect to the longitudinal direction can vary in the transverse direction such that the said angles are greater on the axially outer edges of the layers of metal cords compared to the angles of the said portions measured on the equatorial plane of the tire.

A first embodiment of the alternative form of embodiment of the invention whereby the angles formed by the said metal cords with respect to the longitudinal direction can vary in the transverse direction, consists in varying the angle of the portions monotonously from the equatorial plane of the tire to the edges of the layer of reinforcing elements.

A second embodiment of this alternative form consists in changing the angle in steps from the equatorial plane of the tire to the edges of the layer of reinforcing elements.

A final embodiment of this alternative form consists in changing the angle in such a way that given values are obtained for given axial positions.

Expressed differently, these various embodiments of the alternative form of embodiment of the invention whereby the angles formed by the said metal cords with respect to the longitudinal direction can vary in the transverse direction, make it possible for the crown reinforcing structure to obtain good circumferential rigidity through the presence of close, that is to say small, angles in the region of the crown of the tire, that is to say in the region flanking the equatorial plane. By contrast, open angles, that is to say angles tending towards 90°, can also be obtained on the edges of the layer of reinforcing elements or, more precisely, at the shoulders of the tire in order to improve grip, traction, comfort, or even the operating temperature of the tire; indeed, such variations in angle allow the shear rigidities of the layers of reinforcing elements to be modified.

According to one more particularly advantageous embodiment of the invention, the metal cords that make an angle of between 10 and 90° with respect to the circumferential direction have a penetration ability of between 80 and 100%.

The penetration ability according to the invention is the ability of the rubber compound to penetrate the free regions of a cord, that is to say those regions that do not contain any material; it is expressed as a percentage of the said free regions occupied by compound after curing and is determined by an air permeability test.

This air permeability test makes it possible to measure a relative air permeability index. It is a simple way of indirectly measuring the degree to which the cord has been penetrated by a rubber compound. It is carried out on cords extracted directly, by excision, from the cured rubber plies that they are used to strengthen, and which have therefore been penetrated by vulcanized rubber.

The test is carried out on a determined length of cord (for example 2 cm long) as follows: air is introduced into the beginning of the cord at a given pressure (for example 1 bar) and the amount of air leaving the cable is measured, using a flowmeter; while the measurements are being taken, the cord specimen is immobilized in an airtight seal so that only the amount of air passing along the cord from one end to the other along its longitudinal axis is considered in the measurement. The higher the level of penetration of the cord by the rubber, the lower the measured flowrate.

It has been found that laying metal cords according to the invention, in the layers of the carcass of the tire comprising reinforcing elements that make an angle of between 10 and 90° with respect to the circumferential direction and which have been penetrated by the rubber compound under the abovementioned conditions allow better distribution of stresses between the various threads that make up the cords and therefore even better resistance to the compression and extension cycles.

Such a tire according to the invention will advantageously be produced using a technique involving a hard core. This is because, on the one hand, the metal cords may, for example, be introduced using the technique described in Patent EP 0 248 301 in a precise manner, avoiding the aforementioned problems associated with the placing of a prefabricated element on the toric profile of a motorcycle tire. Furthermore, a manufacturing technique using a hard core can be associated with tire curing performed at high pressure, encouraging the rubber compounds to penetrate the metal cords.

Reinforcing elements more particularly suited to the production of at least one layer of reinforcing elements are, for example, assemblies of the 12.15 formula stranded cable type, the make-up of which is 4×3×0.15, four strands being wound together in a helix with a pitch of 4.6 mm, each of the strands being made up of three metal threads wound together in a helix with a pitch of 3.1 mm, the threads of each strand and the said strands being wound in the same direction of twist S/S or Z/Z, and the twelve threads having a diameter of 0.15 mm.

Another example of a stranded cable suited to the production of a tire according to the invention is a cable of the formula 21.15, the make-up of which is 3×7×0.15, three strands being wound together in a helix with a pitch of 5.3 mm, each of the strands consisting of seven metal threads wound together in a helix with a pitch of 3.2 mm, the threads of each strand and the said strands being wound in the same direction of twist S/S or Z/Z, and the 21 threads having a diameter of 0.15 mm.

According to a preferred embodiment of the invention, the crown reinforcing structure comprises at least two layers of reinforcing elements, the said reinforcing elements making angles of between 20 and 160°, and preferably between 40 and 100° with one another, from one layer to the next.

Advantageously also, the crown reinforcing structure comprises at least one layer of circumferential reinforcing elements and the reinforcing elements in the layer of circumferential reinforcing elements advantageously have an elastic modulus in excess of 6000 N/mm².

Reinforcing elements in the layer of circumferential reinforcing elements may be made of metal and/or textile and/or glass.

The presence of a layer of circumferential reinforcing elements is especially preferable when producing a tire intended to be used on the rear wheel of a motorcycle.

One advantageous embodiment of the invention anticipates that the layer of circumferential reinforcing elements is positioned at least partially radially on the outside of a layer of reinforcing elements that make an angle of between 10 and 90° with respect to the circumferential direction. When the layer of circumferential reinforcing elements is produced radially on the outside of the layers of reinforcing elements that make an angle of between 10 and 90° with respect to the circumferential direction and is positioned directly under the tread, it may in particular contribute to improving high-speed stability.

The layer of circumferential reinforcing elements may thus be produced directly under the tread in order, in addition to performing its main function, also act as a layer that protects the carcass and the other layers of the crown reinforcing structure from any potential mechanical attack.

The layer of circumferential reinforcing elements may alternatively be produced between the layers of reinforcing elements that make an angle of between 10 and 90° with respect to the circumferential direction, particularly for economic reasons, as the amount of material required and the laying time are thereby reduced.

Another advantageous embodiment of the invention anticipates that the layer of circumferential reinforcing elements is positioned at least partially radially on the inside of the layer of reinforcing elements that make an angle of between 10 and 90° with respect to the circumferential direction radially on the inside. In this embodiment, the layer of circumferential reinforcing elements is produced radially on the inside of the layers of reinforcing elements that make an angle of between 10 and 90° with respect to the circumferential direction and may in particular make it possible to improve the grip and the traction of the tire.

An alternative form of the invention anticipates that at least one layer of reinforcing elements, such as a layer of metal cords that makes an angle of between 10 and 90° with respect to the circumferential direction, is positioned at least partially radially on the inside of the carcass-type reinforcing structure.

Another alternative form of the invention anticipates that at least one layer of circumferential reinforcing elements is positioned at least partially radially on the inside of the carcass-type reinforcing structure. This alternative form of embodiment may again adopt the various positionings mentioned previously with respect to the layers of reinforcing elements that make an angle of between 10 and 90° with respect to the circumferential direction.

The carcass may thus cover the entire crown reinforcing structure.

As a preference, the invention anticipates that at least one crown reinforcing layer is positioned between the carcass and the tread in order to protect the carcass.

It should be noted that a tire according to the invention, particularly when at least part of the crown reinforcing structure is produced radially on the inside of the carcass structure, is advantageously produced using a manufacturing technique of the type involving a hard core or rigid form.

Advantageously too, in the case of a radial structure, the reinforcing elements of the carcass-type reinforcing structure make an angle of between 65° and 90° with respect to the circumferential direction.

An advantageous embodiment of the invention also anticipates that the carcass-type reinforcing structure consists of two half-layers running for example from the shoulders to the beads. Depending on the nature, the quantity and the arrangement of the crown reinforcing elements, the invention effectively anticipates eliminating the carcass structure in at least part of that region of the tire that lies under the tread. Such a carcass structure can be produced according to the teachings of document EP-A-0 844 106.

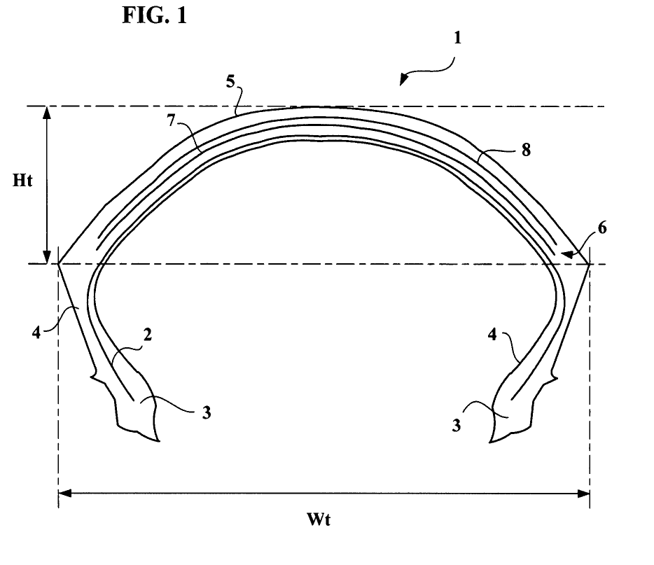

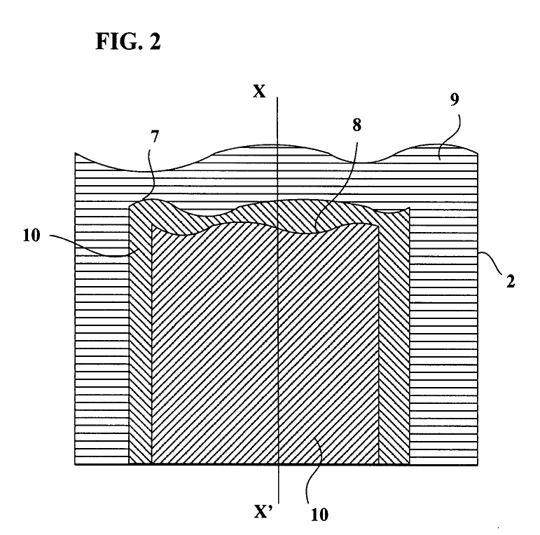

Other details and advantageous features of the invention will become apparent hereinafter from the description of some exemplary embodiments of the invention given with reference to FIGS. 1 and 2 which depict:

FIG. 1: a meridian view of a diagram of a tire according to the invention;

FIG. 2: a plan view with cutaway of the carcass of the tire depicted in FIG. 1; and

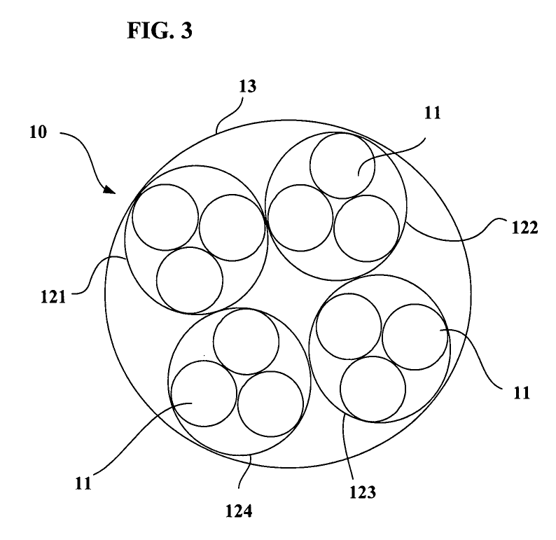

FIG. 3: a schematic sectioned view of a bimodulus cord.

For ease of understanding, the figures are not drawn to scale.

FIG. 1 depicts a tire 1 comprising a carcass consisting of a layer 2 comprising reinforcing elements of a textile type. The layer 2 is made up of reinforcing elements arranged radially. The radial positioning of the reinforcing elements is defined by the angle at which the said reinforcing elements are laid; a radial arrangement corresponds to the said elements being laid at an angle of between 65° and 90° with respect to the longitudinal direction of the tire.

The said carcass layer 2 is anchored on each side of the tire 1 in a bead 3 the base of which is intended to be mounted on a rim seat. Each bead 3 is extended radially outwards in the form of a sidewall 4, the said sidewall 4 radially towards the outside meeting a tread 5. The tire 1 thus formed has a curvature in excess of 0.15 and preferably in excess of 0.3. The curvature is defined by the ratio Ht/Wt, that is to say the ratio of the height of the tread to the maximum width of the tread of the tire. The curvature will advantageously range between 0.25 and 0.5 for a tire intended to be fitted on the front wheel of a motorcycle and will advantageously range between 0.2 and 0.5 for a tire intended to be fitted to the back wheel.

The tire 1 also comprises a crown reinforcement 6 which may, as the case may be, consist of at least two working layers comprising reinforcing elements that are mutually parallel within a given layer and are crossed from one layer to the next and possibly of a layer of circumferential reinforcing elements. According to the invention, the reinforcing elements in the working layers are metal cords and, in this instance, bimodulus cords of the 12.15 type, the make-up of which is 4×3×0.15 (S/S 3.1/4.6); these are depicted in FIG. 3. In the case of the example depicted in the figures, the crown reinforcement consists of two working layers 7, 8 comprising cords that are mutually parallel within a given layer and crossed from one layer to the next.

FIG. 2 depicts a schematic view with cutaway of the architecture of the tire 1, in which the circumferential direction is represented by the line XX′. The carcass, consisting of a layer 2 of textile reinforcing elements 9 at an angle of 90° with respect to the circumferential direction, is covered radially by two layers 7, 8 of cords 10, such as those illustrated in FIG. 3, which are mutually parallel within each layer 7, 8 and crossed from one layer to the next to form angles of about 40° with one another.

FIG. 3 illustrates, in diagrammatic form, a cross section through such a cord 10.

The cord 10 used according to the invention is a stranded cord of formula 12.15, that is to say one made up of 12 elementary threads of a diameter of 15/100 mm; the cord 10 satisfies the formula 4×3×0.15 and has 4 strands twisted together, each one consisting of 3 wound threads 11 of a diameter of 15/100 mm, inscribed inside circles 121, 122, 123, 124 diagrammatically representing the space occupied by each of the strands. FIG. 3 also illustrates the winding of the 4 strands inscribed inside a circle 13 diagrammatically representing the space occupied by the cord formed of the 12 threads. The threads 11 are made of steel.

The tire 1 is advantageously produced using a hard core technique, the said cords being laid, as mentioned before, according to the technique described in Patent EP 0 248 301. A hard core manufacturing technique allows the cords to be held in position right up to the end of tire manufacture and also, when associated with high pressures during the curing stage, makes it possible to ensure satisfactory penetration of the rubber compound into the cords.

Tests have been performed on tires produced in this way. These tests have consisted in running tests on test machines and have been compared with tests performed under the same conditions on other tires of the same size; these are 120/70 ZR 17 tires.

A first category of tires termed the reference tires were tires produced in the conventional way, that is to say with aramid reinforcing elements in the working plies. Other tires tested were produced using metal reinforcing elements in the working plies, the said reinforcing elements not being “bimodulus” cords but cords of the 4×23 formula.

The test conditions were the same for all the tires; the tires were inflated to 2.5 bar and subjected to a standard front tire load. During the running cycle, the tires had slip cycles imposed on them.

The results for the reference tires showed the reinforcing elements in the working plies to be in a condition considered to be acceptable after the tires had run a distance corresponding to at least twice the mean wear life for this kind of tire.

The results for the tires according to the invention showed that the cords in the working plies were in a condition comparable to that of the reference tires, and therefore acceptable, after running for the same distance.

The results for the tires comprising metal 4×23 cords in the working plies showed that the cords in the working plies were damaged, the tires being considered unserviceable, when they had run only half the distance of the previous running tests.

These tests have therefore demonstrated that using metal cords of the bimodulus type, perfectly impregnated with rubber compound, allows the tires to run with no ill effect on durability.

1. A tire for a motorized two-wheeled vehicle such as a motorcycle, comprising at least one reinforcing structure of the carcass type, formed of reinforcing elements, anchored on each side of the tire into a bead the base of which is intended to be mounted on a rim seat, each bead extending radially outwards in the form of a sidewall, the sidewalls radially towards the outside meeting a tread, and comprising, under the tread, a crown reinforcing structure including at least one layer of reinforcing elements, said reinforcing elements making an angle of between 10 and 90° with respect to the circumferential direction, wherein said reinforcing elements that make an angle of between 10 and 90° with respect to the circumferential direction are metal cords of which the curve of tensile stress as a function of relative elongation exhibits shallow gradients for small elongations and a substantially constant and steep gradient for greater elongations.

2. The tire according to claim 1, wherein the metal cords that make an angle of between 10 and 90° with respect to the circumferential direction have a penetration ability of between 80 and 100%.

3. The tire according to claim 1, comprising, under the tread, a crown reinforcing structure, characterized in that the crown reinforcing structure comprises at least two layers of reinforcing elements and in that, from one layer to the next, the reinforcing elements make angles of between 20 and 160° with one another.

4. The tire according to claim 1, wherein the angles formed by the metal cords with respect to the longitudinal direction can vary in the transverse direction and in that the said angles are greater on the axially outer edges of the layers of reinforcing elements compared to the angles of the said metal cords measured on the equatorial plane of the tire.

5. The tire according to claim 1, wherein the crown reinforcing structure comprises at least one layer of circumferential reinforcing elements.

6. The tire according to claim 5, wherein the reinforcing elements in the layer of circumferential reinforcing elements have an elastic modulus in excess of 6000 N/mm².

7. The tire according to claim 5, wherein the reinforcing elements in the layer of circumferential reinforcing elements are made of metal and/or textile and/or glass.

8. The tire according to claim 5, wherein the layer of circumferential reinforcing elements is positioned at least partially radially on the outside of a layer of reinforcing elements that make an angle of between 10 and 90° with respect to the circumferential direction.

9. The tire according to claim 5, wherein the layer of circumferential reinforcing elements is positioned at least partially radially on the inside of a layer of reinforcing elements that make an angle of between 10 and 90° with respect to the circumferential direction radially on the inside.

10. The tire according to claim 1, wherein at least one layer of reinforcing elements is positioned at least partially radially on the inside of the carcass-type reinforcing structure.

11. The tire according to claim 1, wherein the reinforcing elements of the carcass-type reinforcing structure make an angle of between 65° and 90° with respect to the circumferential direction.

12. The tire according to claim 1, wherein the carcass-type reinforcing structure is made in two half-layers running from the shoulders to the beads.
